(19) United States
(12) Patent Application Publication
(10) Pub. No.: US 2007/0266636 A1
(43) Pub. Date: Nov. 22, 2007

(54) Chain movement apparatus or slats of transom shutters

(76) Inventor: Chin-Fu Chen, Taichung City (TW)

Correspondence Address: BIRCH STEWART KOLASCH & BIRCH, PO BOX 747, FALLS CHURCH, VA, 22040-0747, US

(21) Appl. No.: 11/437,739

(22) Filed: May 22, 2006

(51) Int. Cl. E06B 7/096

(52) U.S. Cl. 49/82.1

(57) ABSTRACT

A chain movement apparatus for slats of transom shutters to regulate the inclined angle of slats located on a frame. The apparatus includes a moving member and a plurality of rotary members. The slats have at least one end fastened to the rotary members. The rotary members are engaged concurrently with the moving member so that movement of the moving member can synchronously drive and turn the rotary members. Therefore users can turn any one of the slats to activate a chain movement for the rest of slats to turn at the same time to enable the users to adjust the inclined angle of the slats as desired.

### FIELD OF THE INVENTION

The present invention relates to a transom shutter and particularly to a chain movement apparatus for slats of transom shutters.

### BACKGROUND OF THE INVENTION

Referring to FIGS. 1 and 2, a conventional transom shutter 1 mainly includes a frame 2 which has a plurality of slats 3 located in the middle in an equally spaced manner. Each of the slats 3 has a left end and a right end hinged on the frame 2 to allow each slat 3 to be turned. The slats 3 have a front end jointly coupled with a drawing bar 4 in the middle. Hence by moving the drawing bar 4 downwards as shown in FIG. 2, the slats 3 can be swayed downwards in an inclined manner like stacking fish scales to block light. Moving the drawing bar 4 upwards, the slats 3 can be swayed upwards to become horizontal and spaced from one another so that outdoor light can pass through and outdoor air can enter indoors to facilitate air circulation.

However, adjustment of the slats 3 of the conventional transom shutter 1 has to rely on the drawing bar 4 which is located on the front side and spoils the entire visual sight. The aesthetic appeal of the transom shutter 1 suffers. The drawing bar 4 also hinders outdoor light projection and air circulation. Hence it cannot fully meet user's requirements.

### SUMMARY OF THE INVENTION

Therefore the primary object of the present invention is to provide a chain movement apparatus for slats of transom shutters to maintain overall integration and aesthetic appeal of the transom shutter without affecting projection of outdoor light and air circulation to better meet user's requirements.

The chain movement apparatus for slats of transom shutters according to the invention is adopted for use on a transom shutter which has a frame and a plurality of slats. The slats are hinged on the frame. The apparatus also has a plurality of rotary members and at least one moving member. Each of the slats has at least one fastened to one rotary member. The rotary members are engaged with the moving member concurrently. When the moving member is moved, it drives the rotary members to rotate synchronously.

Thus when any one of the slats is turned, the rest of slats can be turned and alter the inclined angle through the chain movement of the rotary members and the moving member.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional transom shutter in an open condition.

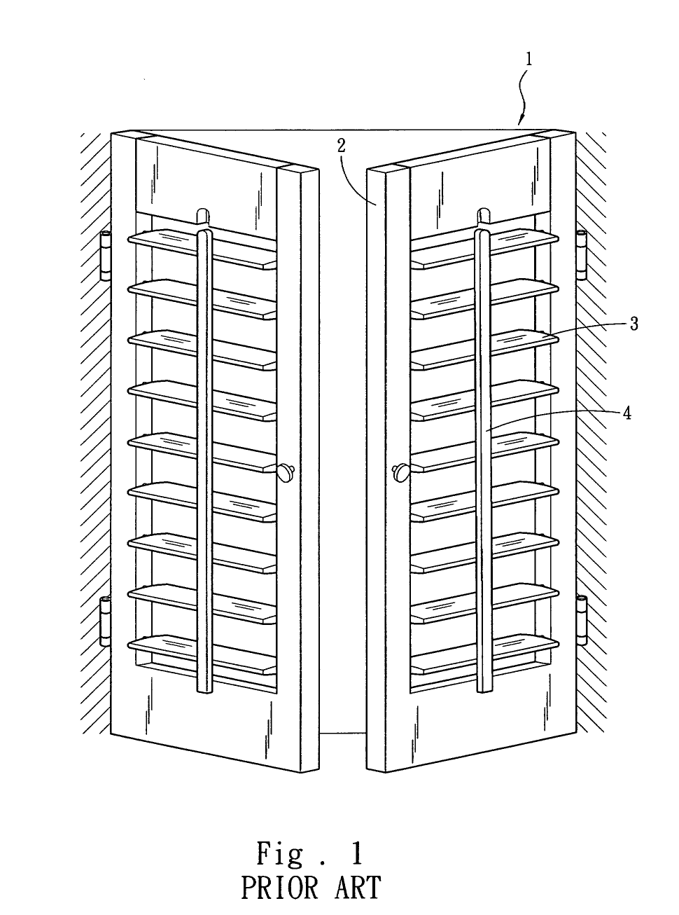

FIG. 2 is a perspective view of a conventional transom shutter in a closed condition.

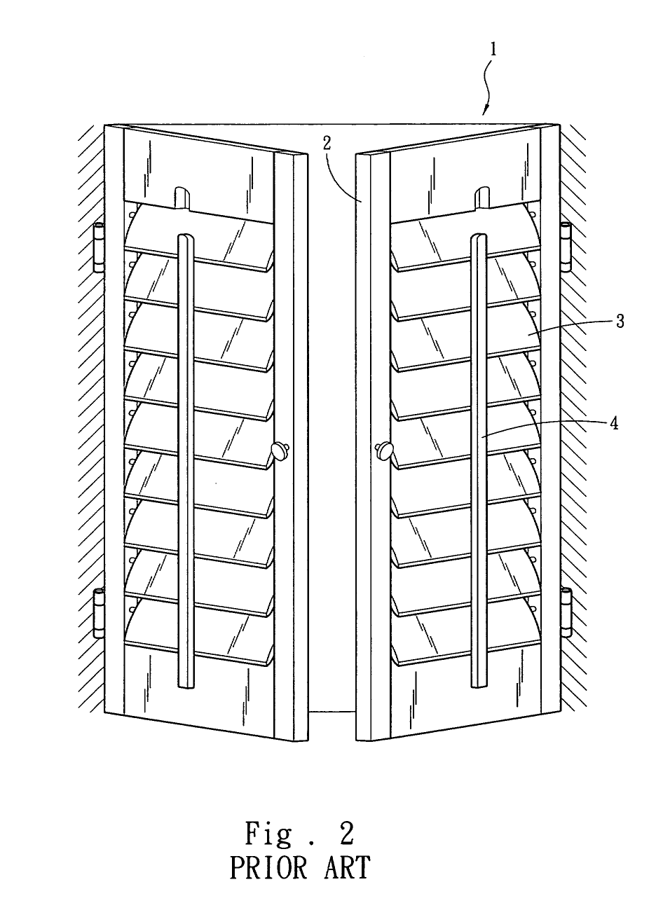

FIG. 3A is a schematic view of the transom shutter of the invention.

FIG. 3B is a fragmentary enlarged view of FIG. 3A.

FIG. 4 is a perspective view of the transom shutter of the invention.

FIG. 5 is a perspective view of the transom shutter of the invention in a closed condition.

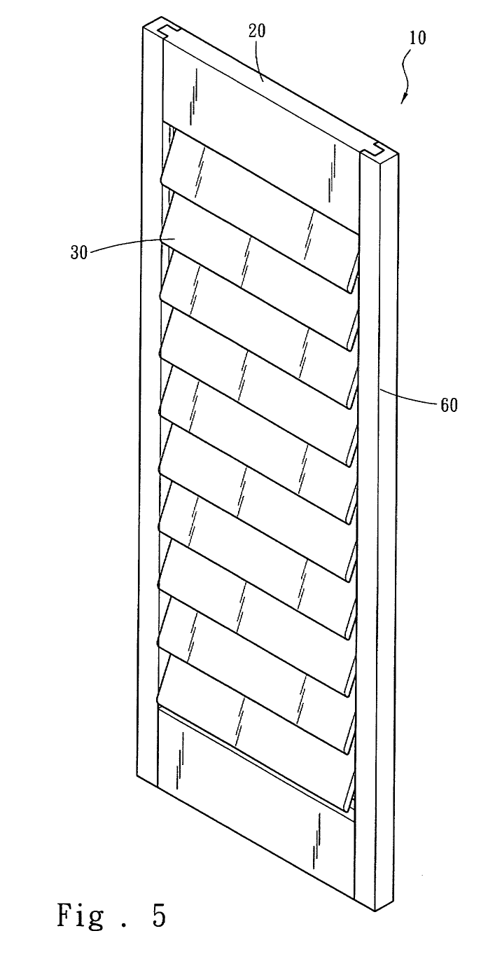

### DETAILED DESCRIPTION OF THE PREFERRED EMBODIMENTS

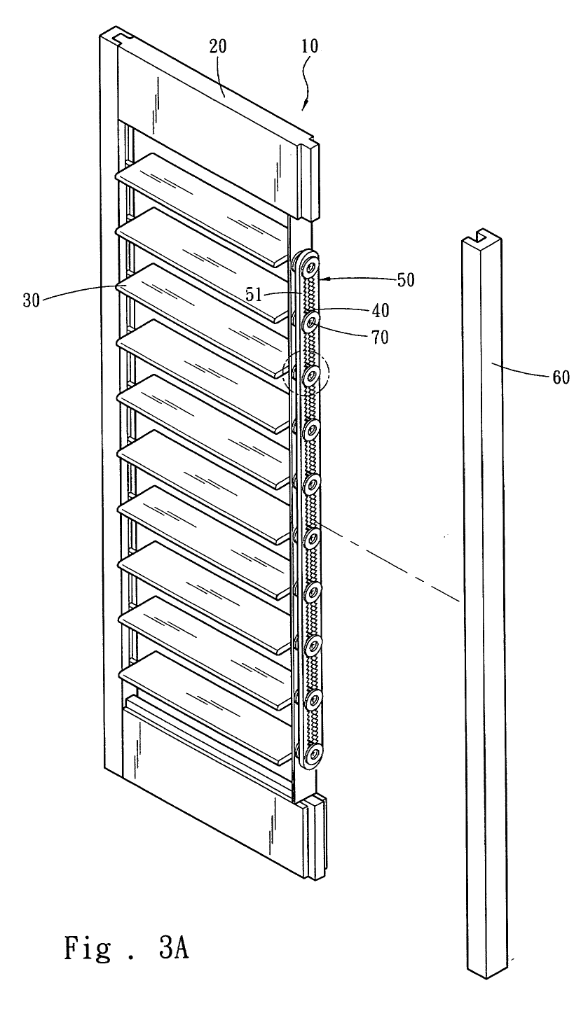

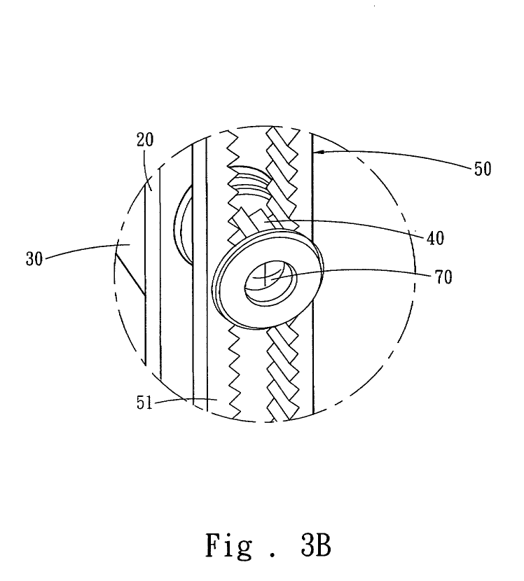

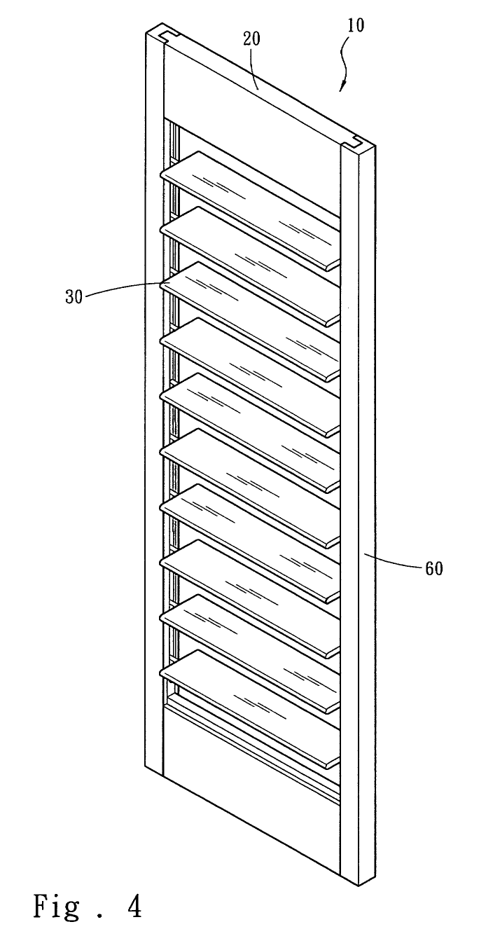

Please refer to FIGS. 3A, 3B and 4, the chain movement apparatus for slats of transom shutters is adopted for use on a transom shutter 10 which has a frame 20 and a plurality of slats 30. The slats 30 are hinged on the frame 20 which has a plurality of rotary members 40 and at least one moving member 50. Each of the slats 30 has at least one end fastened to one of the rotary member 40. The rotary members 40 are engaged with the moving member 50 concurrently. Hence the moving member 50 can drive the rotary members 40 to turn synchronously. It is to be noted that the rotary members 40 can be located on an outer side of the frame 20 to be fastened respectively to one end of the slats 30 through a screw 70 running through the frame 20 (as shown in FIG. 3B). The rotary members 40 may also be located on an inner side of the frame 20 to be fastened directly to one end of the slats 30. The slats 30 are hinged on the frame 20 through the rotary members 40.

The rotary members 40 may be gears. The moving member 50 may be a corresponding gear rack engaged with the rotary members 40. The rotary members 40 may also be chain wheels while the moving member 50 is a corresponding chain mating the chain wheels so that they can engage together.

To achieve a secure chain movement for the rotary members 40 through the moving member 50, the moving member 50 may surround two sides of the rotary members 40 and engage with the rotary members 40 on an upper side and a lower side. In the event that the rotary members 40 are gears, the moving member 50 is a pliable cog belt 51. The pliable cog belt 51 is an annular ring to surround the gears and engage with the rotary members 40 on the upper side and the lower side.

In the event that the rotary members 40 are chain wheels, the moving member 50 is a corresponding chain. The chain is an annular ring to wind on the chain wheels such that the moving member 50 engages with the rotary members 40 on the upper side and the lower side.

The slats 30 may have two ends fastened to the rotary members 40 to reduce the stress when driven by the moving member 50 thereby to increase the life span of the rotary members 40 and the moving member 50. To enhance aesthetic appearance, the frame 20 may be covered by a frame cover 60 to mask the rotary members 40 and the moving member 50.

By means of the construction set forth above, users can turn any one of the slats 30 on the transom shutter 10 to activate the chain movement of the rotary members 40 and the moving member 50. Hence the rest of slats 30 can be turned synchronously to a desired inclined angle to achieve light regulation and air circulation effect. As the apparatus of the invention is not directly installed in the middle portion of the slats 30, it does not affect the appearance, and also does not affect projecting of the outdoor light and air circulation. In addition, with the frame cover 60 masking the rotary members 40 and the moving member 50 that are unsightly, the integrity and appeal of the entire transom shutter 10 can be maintained intact to better meet user's requirements.

What is claimed is:

1. A chain movement apparatus for slats of transom shutters to be used on a transom shutter which includes a frame and a plurality of slats hinged on the frame, comprising:
a plurality of rotary members fastened to at least one end of the slats; and
at least one moving member engaging with the rotary members concurrently and being movable to drive and turn the rotary members synchronously.

2. The chain movement apparatus of claim 1, wherein the rotary members are gears and the moving member is a gear rack corresponding to the gears to engage with the rotary members.

3. The chain movement apparatus of claim 1, wherein the rotary members are chain wheels and the moving member is a chain corresponding to the chain wheels to engage with rotary members.

4. The chain movement apparatus of claim 1, wherein the moving member surrounds two sides of the rotary members and engages with the rotary members on a upper side and a lower side.

5. The chain movement apparatus of claim 4, wherein the rotary members are gears and the moving member is an annular and pliable cog belt surrounding and coupling with the gears and engaging with the rotary members on the upper side and the lower side.

6. The chain movement apparatus of claim 4, wherein the rotary members are chain wheels and the moving member is an annular chain corresponding to and coupling with the chain wheels and engaging with the rotary members on the upper side and the lower side.

7. The chain movement apparatus of claim 1, wherein the rotary members are fastened to two ends of the slats.

8. The chain movement apparatus of claim 1, wherein the frame has a frame cover to mask the rotary members and the moving member.

9. The chain movement apparatus of claim 1, wherein the rotary members are located on an outer side of the frame and fastened to the one end of the slats through a screw running through the frame.

10. The chain movement apparatus of claim 1, wherein the rotary members are located on an inner side of the frame and fastened to the one end of the slats which are hinged on the frame through the rotary members.
